(19) United States
(12) Patent Application Publication
(10) Pub. No.: US 2021/0220695 A1
(43) Pub. Date: Jul. 22, 2021

(54) Multilayer Treadmill Walking Board Assembly that Eliminates Static Electricity and Achieves Wearproof and Lubricating Purposes

(71) Applicant: Yu-Lun Tsai, Taichung City (TW)

(72) Inventor: Yu-Lun Tsai, Taichung City (TW)

(21) Appl. No.: 16/745,634

(22) Filed: Jan. 17, 2020

(51) Int. Cl. A63B 22/02; B32B 9/00

(52) U.S. Cl. CPC A63B 22/0285; B32B 9/007; B32B 2264/108; B32B 2307/72; B32B 2318/00; B32B 2307/554

(57) ABSTRACT

A multilayer treadmill walking board assembly includes a support board, and a coating secured on a top face of the support board. The coating includes a wear-resistant layer, a lubricating layer, and an antistatic layer. The wear-resistant layer is located between the support board and the lubricating layer. The lubricating layer is located between the wear-resistant layer and the antistatic layer. Thus, the multilayer treadmill walking board assembly has an antistatic function by provision of the antistatic layer, has a lubricating function by provision of the lubricating layer, and has a wear-resistant function by provision of the wear-resistant layer.

### BACKGROUND OF THE INVENTION

### 1. Field of the Invention

The present invention relates to a treadmill and, more particularly, to a walking board assembly for a treadmill.

### 2. Description of the Related Art

A conventional treadmill comprises a walking board, a walking belt, and a plurality of rollers. The walking belt rotates on the walking board along a closed trajectory, to facilitate the user stepping on the walking board successively. The walking belt, the rollers and the walking board rub mutually for a long time, to accumulate static electricity, and to discharge the static electricity to the user, thereby scaring the user and causing an uncomfortable sensation to the user, and easily interfering with the electronic components of the treadmill An antistatic yarn is added to the inner side of the walking belt to eliminate the static electricity. However, the antistatic yarn is easily worn out when the walking belt and the walking board rub constantly during a long-term utilization, and loses its antistatic effect gradually. The walking belt, the rollers, and the walking board rub frequently, such that the walking belt and the walking board are easily worn out during a long-term utilization, thereby decreasing the lifetime of the walking belt and the walking board. A slip assistant strip is adhered to the inner side of the walking belt to reduce the friction between the walking belt and the walking board. Alternatively, a melamine layer is stuck on the top surface of the walking board to reduce the friction between the walking belt and the walking board. However, the friction produces a high temperature. Moreover, a wear-resistant and high-temperature resistant surface layer is stuck to the walking board, and a lubricant or wax is sprayed on the surface layer, to reduce the friction between the walking belt and the walking board, such that the walking belt is moving on the walking board smoothly, thereby preventing from producing resistance and high temperature due to frequent friction during a long-term utilization. However, the user has to replenish the lubricant or wax during a period of time, thereby greatly causing inconvenience to the user, and thereby increasing the cost.

### BRIEF SUMMARY OF THE INVENTION

The primary objective of the present invention is to provide a multilayer treadmill walking board assembly that eliminates static electricity and achieves wearproof and lubricating purposes.

In accordance with the present invention, there is provided a multilayer treadmill walking board assembly comprising a support board, and a coating secured on a top face of the support board. The coating includes a wear-resistant layer, a lubricating layer, and an antistatic layer. The wear-resistant layer is located between the support board and the lubricating layer. The lubricating layer is located between the wear-resistant layer and the antistatic layer. The coating is applied on the support board one time. The coating is made of a composite material. The composite material is heated by a thermal reaction under a high temperature, and is then applied on the support board. The composite material is then cooled and solidified to form the coating. The composite material includes a plurality of components having different weight proportion, density and specific gravity. The composite material of the coating produces a stepwise multilayer deposit gradually by gravity and material state of the components during a cooling solidification process, and in turn forms the wear-resistant layer, the lubricating layer located above the wear-resistant layer, and the antistatic layer located above the lubricating layer. Thus, the multilayer treadmill walking board assembly has an antistatic function by provision of the antistatic layer, has a lubricating function by provision of the lubricating layer, and has a wear-resistant function by provision of the wear-resistant layer.

According to the primary advantage of the present invention, the antistatic layer of the coating contains the graphite mixture and the antistatic agent, and is added with a macromolecule compound with a high conducting feature, such that the upper face of the multilayer treadmill walking board assembly has a better lubricating effect, to assist a sliding movement of the walking belt, and to reduce the friction between the walking belt and the support board, thereby preventing from incurring a wear therebetween, and thereby enhancing the lifetime of the walking belt and the support board.

According to another advantage of the present invention, the coating eliminates the static electricity such that the friction between the walking belt and the support board will not accumulate the static electricity.

According to a further advantage of the present invention, the coating with a predetermined thickness is integrally applied on the support board by a spreading machine or an applicator, and is cured and secured to the support board rapidly, such that the coating and the support board are combined closely and tightly by the adhesive feature of the resin, and will not be detached from each other.

According to a further advantage of the present invention, the antistatic coefficient of the antistatic layer, the lubricating coefficient of the lubricating layer, and the friction coefficient of the wear-resistant layer are not reduced or eliminated during a long-term utilization.

According to a further advantage of the present invention, the component proportion of the composite material of the coating is adjusted according a customized requirement, so as to change the antistatic degree of the antistatic layer, the lubricating degree of the lubricating layer, and the wear-resistant degree of the wear-resistant layer.

According to a further advantage of the present invention, the thickness of the coating is adjusted according a customized requirement.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a side cross-sectional view of a multilayer treadmill walking board assembly in accordance with the preferred embodiment of the present invention.

### DETAILED DESCRIPTION OF THE INVENTION

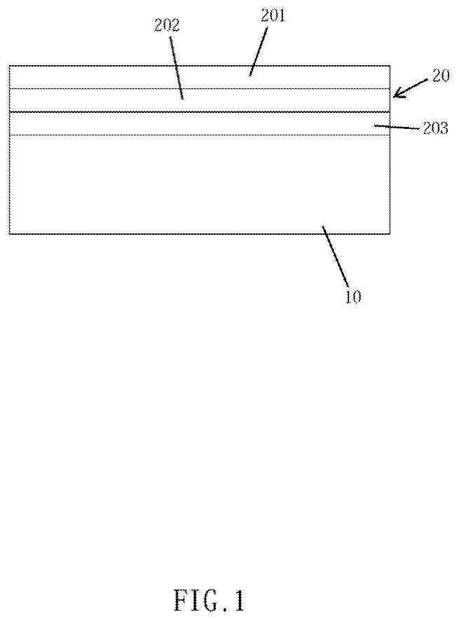

Referring to FIG. 1, a multilayer treadmill walking board assembly in accordance with the preferred embodiment of the present invention comprises a support board 10, and a coating 20 secured on a top face of the support board 10. The coating 20 includes a wear-resistant layer 203, a lubricating layer 202, and an antistatic layer 201. The wear-resistant layer 203 is located between the support board 10 and the lubricating layer 202. The lubricating layer 202 is located between the wear-resistant layer 203 and the antistatic layer 201.

The coating 20 is applied on the support board 10 one time. The coating 20 is made of a composite material. The composite material is heated by a thermal reaction under a high temperature, and is then applied on the support board 10. The composite material is then cooled and solidified to form the coating 20. The composite material includes a plurality of components having different weight proportion, density and specific gravity. The composite material of the coating 20 produces a stepwise (or gradient) multilayer deposit (or sediment) gradually by gravity and material state of the components during a cooling solidification process, and in turn forms the wear-resistant layer 203, the lubricating layer 202 located above the wear-resistant layer 203, and the antistatic layer 201 located above the lubricating layer 202. Thus, the multilayer treadmill walking board assembly has an antistatic function by provision of the antistatic layer 201, has a lubricating function by provision of the lubricating layer 202, and has a wear-resistant function by provision of the wear-resistant layer 203.

In practice, when the user is stepping or running on the multilayer treadmill walking board assembly, no static electricity will produce. In addition, when the walking belt rubs the multilayer treadmill walking board assembly constantly, the multilayer treadmill walking board assembly eliminates the static electricity and achieves wear-resistant and lubricating purposes, thereby enhancing the lifetime of the treadmill and the parts thereof

In the preferred embodiment of the present invention, the support board 10 is made of wooden material.

In another preferred embodiment of the present invention, the support board 10 is made of plastic material. In the preferred embodiment of the present invention, the components of the composite material of the coating 20 have a weight proportion including: a resin of 100 g, a catalyst of 0.2-0.8 g, a hardener of 0.5-2.5 g, a mineral powder of 20.0-45.0 g, a lubricating oil of 5.0-10.0 g, and a graphite mixture of 15.0-40.0 g.

In the preferred embodiment of the present invention, the components of the composite material of the coating 20 have a density or specific gravity including: the resin of 0.85-1.1, the mineral powder of 4.0-6.5, the lubricating oil of 0.7-0.75, and the graphite mixture of 1.35-3.0.

In the preferred embodiment of the present invention, the components of the composite material of the coating 20 further include an antistatic agent. Thus, the components of the composite material of the coating 20 primarily include the resin, the catalyst, the hardener, the mineral powder, the lubricating oil, the graphite mixture, and the antistatic agent.

In the preferred embodiment of the present invention, the thermal reaction of the composite material is under a temperature of 85° C. when the composite material is applied on the support board 10.

In the preferred embodiment of the present invention, the coating 20 has a multilayer specific gravity of 1.15-3.85 from top to bottom.

In the preferred embodiment of the present invention, the cooling solidification process of the composite material of the coating 20 is performed during a time interval of 2-5 minutes.

A method for manufacturing the multilayer treadmill walking board assembly in accordance with the preferred embodiment of the present invention comprises a first step, a second step, and a third step.

The first step includes preparing a plurality of components having a weight proportion including: a resin of 100 g, a catalyst of 0.2-0.8 g, a hardener of 0.5-2.5 g, a mineral powder of 20.0-45.0 g, a lubricating oil of 5.0-10.0 g, and a graphite mixture of 15.0-40.0 g, and having a density/specific gravity including: the resin of 0.85-1.1, the mineral powder of 4.0-6.5, the lubricating oil of 0.7-0.75, and the graphite mixture of 1.35-3.0. The graphite mixture is made of an antistatic material, and is added with a macromolecule (or polymer) compound with a high conducting feature. In addition, the graphite mixture is further added with an antistatic agent according a customized requirement, such that the antistatic layer 201 has a better antistatic effect. The first step further includes mixing and stirring the components to form the composite material.

The second step includes applying (or spreading or coating or painting) the composite material on the top face of the support board 10 one time, to form the coating 20.

The third step includes heating the composite material by a resin thermal reaction under a high temperature of 85° C., and quickly reducing the temperature to the normal value of about 20-30° C., so as to cool and solidify the coating 20 during a time interval of 2-5 minutes. At this time, the composite material of the coating 20 produces a stepwise multilayer deposit gradually by the relative different density/specific gravity, the gravity, and the material state of the components during the cooling solidification process, such that the component having a greater specific gravity is located at a lower position of the coating 20, and the component having a smaller specific gravity is located at an upper position of the coating 20, thereby in turn forming the wear-resistant layer 203, the lubricating layer 202, and the antistatic layer 201 from bottom to top. In addition, the coating 20 has a multilayer specific gravity of 1.15-3.85 from top to bottom. Besides, the graphite mixture and the antistatic agent have smaller specific gravity, such that the content of the graphite mixture and the antistatic agent is decreased gradually from top to bottom.

Finally, the coating 20 is cured to form the product which includes the wear-resistant layer 203, the lubricating layer 202 located above the wear-resistant layer 203, and the antistatic layer 201 located above the lubricating layer 202. Thus, the coating 20 has an antistatic function by provision of the antistatic layer 201, has a lubricating function by provision of the lubricating layer 202, and has a wear-resistant function by provision of the wear-resistant layer 203.

Accordingly, the antistatic layer 201 of the coating 20 contains the graphite mixture and the antistatic agent, and is added with a macromolecule compound with a high conducting feature, such that the upper face of the multilayer treadmill walking board assembly has a better lubricating effect, to assist a sliding movement of the walking belt, and to reduce the friction between the walking belt and the support board 10, thereby preventing from incurring a wear therebetween, and thereby enhancing the lifetime of the walking belt and the support board 10.

In addition, the coating 20 eliminates the static electricity such that the friction between the walking belt and the support board 10 will not accumulate the static electricity.

Further, the coating 20 with a predetermined thickness is integrally applied on the support board 10 by a spreading machine or an applicator, and is cured and secured to the support board 10 rapidly, such that the coating 20 and the support board 10 are combined closely and tightly by the adhesive feature of the resin, and will not be detached from each other.

Further, the antistatic coefficient of the antistatic layer 201, the lubricating coefficient of the lubricating layer 202, and the friction coefficient of the wear-resistant layer 203 are not reduced or eliminated during a long-term utilization.

Further, the component proportion of the composite material of the coating 20 is adjusted according a customized requirement, so as to change the antistatic degree of the antistatic layer 201, the lubricating degree of the lubricating layer 202, and the wear-resistant degree of the wear-resistant layer 203.

Further, the thickness of the coating 20 is adjusted according a customized requirement.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A multilayer treadmill walking board assembly comprising:
a support board; and
a coating secured on a top face of the support board;
wherein:
the coating includes a wear-resistant layer, a lubricating layer, and an antistatic layer;
the wear-resistant layer is located between the support board and the lubricating layer;
the lubricating layer is located between the wear-resistant layer and the antistatic layer;
the coating is applied on the support board one time;
the coating is made of a composite material;
the composite material is heated by a thermal reaction under a high temperature, and is then applied on the support board;
the composite material is then cooled and solidified to form the coating;
the composite material includes a plurality of components having different weight proportion, density and specific gravity;
the composite material of the coating produces a stepwise multilayer deposit gradually by gravity and material state of the components during a cooling solidification process, and in turn forms the wear-resistant layer, the lubricating layer located above the wear-resistant layer, and the antistatic layer located above the lubricating layer; and
the multilayer treadmill walking board assembly has an antistatic function by provision of the antistatic layer, has a lubricating function by provision of the lubricating layer, and has a wear-resistant function by provision of the wear-resistant layer.

2. The multilayer treadmill walking board assembly of claim 1, wherein the support board is made of wooden material.

3. The multilayer treadmill walking board assembly of claim 1, wherein the support board is made of plastic material.

4. The multilayer treadmill walking board assembly of claim 1, wherein the components of the composite material of the coating have a weight proportion including: a resin of 100 g, a catalyst of 0.2-0.8 g, a hardener of 0.5-2.5 g, a mineral powder of 20.0-45.0 g, a lubricating oil of 5.0-10.0 g, and a graphite mixture of 15.0-40.0 g.

5. The multilayer treadmill walking board assembly of claim 4, wherein the components of the composite material of the coating have a density or specific gravity including: the resin of 0.85-1.1, the mineral powder of 4.0-6.5, the lubricating oil of 0.7-0.75, and the graphite mixture of 1.35-3.0.

6. The multilayer treadmill walking board assembly of claim 1, wherein the components of the composite material of the coating further include an antistatic agent.

7. The multilayer treadmill walking board assembly of claim 1, wherein the thermal reaction of the composite material is under a temperature of 85° C. when the composite material is applied on the support board.

8. The multilayer treadmill walking board assembly of claim 1, wherein the coating has a multilayer specific gravity of 1.15-3.85 from top to bottom.

9. The multilayer treadmill walking board assembly of claim 1, wherein the cooling solidification process of the composite material of the coating is performed during a time interval of 2-5 minutes.
